(19) United States
(12) Patent Application Publication
(10) Pub. No.: US 2010/0162179 A1
(43) Pub. Date: Jun. 24, 2010

(54) Method and Apparatus for Adding or Deleting at Least One Item Based at Least in Part on a Movement

(75) Inventor: Ofri Olavi Porat, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/340,434

(22) Filed: Dec. 19, 2008

(51) Int. Cl. G06F 3/048

(52) U.S. Cl. 715/863

(57) ABSTRACT

In accordance with an example embodiment of the present invention, an apparatus comprising a user interface configured to detect a first touch, detect a second touch, and detect a movement from the first touch or the second touch. The apparatus further comprises a processor configured to delete or add at least one item based at least in part on the movement.

### TECHNICAL FIELD

The present application relates generally to adding or deleting at least one item based at least in part on a movement.

### BACKGROUND

A user may use an electronic device to use applications. Further, the electronic device may provide different types of applications. As such, the electronic device facilitates use different types of applications.

### SUMMARY

Various aspects of examples of the invention are set out in the claims.

According to a first aspect of the present invention, an apparatus comprising a user interface configured to detect a first touch, detect a second touch, and detect a movement from the first touch or the second touch. The apparatus further comprises a processor configured to delete or add at least one item based at least in part on the movement.

According to a second aspect of the present invention, a method comprising detecting a first touch, detecting a second touch, detecting a movement from the first touch or the second touch, and deleting or adding at least one item based at least in part on the movement.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram depicting an electronic device operating in accordance with an example embodiment of the invention;

FIG. 2A is screen views of an electronic device deleting an item in accordance with an example embodiment of the invention;

FIG. 2B is screen views of an electronic device deleting more than one item in accordance with an example embodiment of the invention;

FIG. 3 is screen views of an electronic device adding an item in accordance with an example embodiment of the invention;

FIGS. 4A-B is screen views of another electronic device deleting an item in accordance with an example embodiment of the invention;

FIGS. 4C-D is screen views of another electronic device deleting more than one item in accordance with an example embodiment of the invention;

FIGS. 5A-B is screen views of another electronic device adding an item in accordance with an example embodiment of the invention;

FIGS. 6A-C is screen views of another electronic device deleting an item in accordance with an example embodiment of the invention; and

FIGS. 7A-C is screen views of another electronic device adding an item in accordance with an example embodiment of the invention.

### DETAILED DESCRIPTION OF THE DRAWINGS

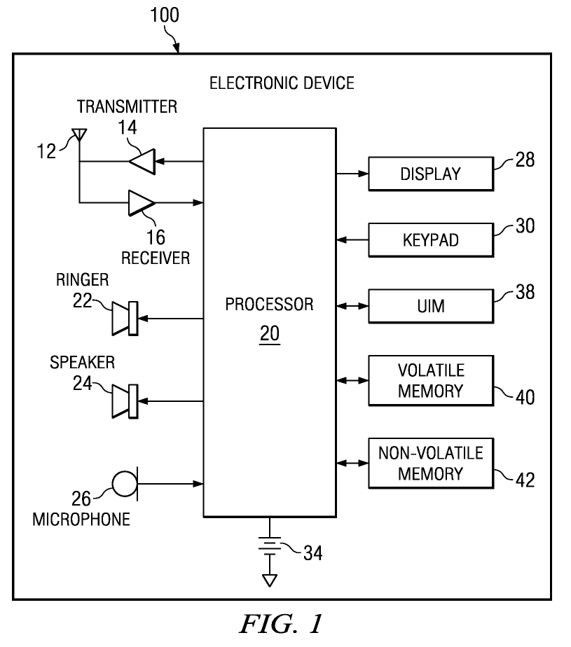

An example embodiment of the present invention and its potential advantages are best understood by referring to FIGS. 1 through 7C of the drawings.

FIG. 1 is a block diagram depicting an electronic device 100 operating in accordance with an example embodiment of the invention. In an example embodiment, an electronic device 100 comprises at least one antenna 12 in communication with a transmitter 14, a receiver 16, and/or the like. The electronic device 100 may further comprise a processor 20 or other processing component. The processor 20 may provide at least one signal to the transmitter 14 and may receive at least one signal from the receiver 16. In an embodiment, the electronic device 100 may also comprise a user interface comprising one or more input or output devices, such as a conventional earphone or speaker 24, a ringer 22, a microphone 26, a display 28, and/or the like. In an embodiment, the one or more output devices of the user interface may be coupled to the processor 20. In an example embodiment, the display 28 is a touch screen, liquid crystal display, and/or the like.

In an embodiment, the electronic device 100 may also comprise a battery 34, such as a vibrating battery pack, for powering various circuits to operate the electronic device 100. Further, the vibrating battery pack may also provide mechanical vibration as a detectable output. In an embodiment, the electronic device 100 may further comprise a user identity module (UIM) 38. In one embodiment, the UIM 38 may be a memory device comprising a processor. The UIM 38 may comprise, for example, a subscriber identity module (SIM), a universal integrated circuit card (UICC), a universal subscriber identity module (USIM), a removable user identity module (R-UIM), and/or the like. Further, the UIM 38 may store one or more information elements related to a subscriber, such as a mobile subscriber.

In an embodiment, the electronic device 100 may comprise memory. For example, the electronic device 100 may comprise volatile memory 40, such as random access memory (RAM). Volatile memory 40 may comprise a cache area for the temporary storage of data. Further, the electronic device 100 may also comprise non-volatile memory 42, which may be embedded and/or may be removable. The non-volatile memory 42 may also comprise an electrically erasable programmable read only memory (EEPROM), flash memory, and/or the like. In an alternative embodiment, the processor 20 may comprise memory. For example, the processor 20 may comprise volatile memory 40, non-volatile memory 42, and/or the like.

In an embodiment, the electronic device 100 may use memory to store any of a number of pieces of information and/or data to implement one or more features of the electronic device 100. Further, the memory may comprise an identifier, such as international mobile equipment identification (IMEI) code, capable of uniquely identifying the electronic device 100. The memory may store one or more instructions for determining cellular identification information based at least in part on the identifier. For example, the processor 20, using the stored instructions, may determine an identity, e.g., cell id identity or cell id information, of a communication with the electronic device 100.

In an embodiment, the processor 20 of the electronic device 100 may comprise circuitry for implementing audio feature, logic features, and/or the like. For example, the processor 20 may comprise a digital signal processor device, a microprocessor device, a digital to analog converter, other support circuits, and/or the like. In an embodiment, control and signal processing features of the processor 20 may be allocated between devices, such as the devices describe above, according to their respective capabilities. Further, the processor 20 may also comprise an internal voice coder and/or an internal data modem. Further still, the processor 20 may comprise features to operate one or more software programs. For example, the processor 20 may be capable of operating a software program for connectivity, such as a conventional Internet browser. Further, the connectivity program may allow the electronic device 100 to transmit and receive Internet content, such as location-based content, other web page content, and/or the like. In an embodiment, the electronic device 100 may use a wireless application protocol (WAP), hypertext transfer protocol (HTTP), file transfer protocol (FTP) and/or the like to transmit and/or receive the Internet content.

In an embodiment, the electronic device 100 may be capable of operating in accordance with any of a number of a first generation communication protocol, a second generation communication protocol, a third generation communication protocol, a fourth generation communication protocol, and/or the like. For example, the electronic device 100 may be capable of operating in accordance with second generation (2G) communication protocols IS-136, time division multiple access (TDMA), global system for mobile communication (GSM), IS-95 code division multiple access (CDMA), and/or the like. Further, the electronic device 100 may be capable of operating in accordance with third-generation (3G) communication protocols, such as Universal Mobile Telecommunications System (UMTS), CDMA2000, wideband CDMA (WCDMA), time division-synchronous CDMA (TD-SCDMA), and/or the like. Further still, the electronic device 100 may also be capable of operating in accordance with 3.9 generation (3.9G) wireless communication protocols, such as Evolved Universal Terrestrial Radio Access Network (E-UTRAN) or the like, or wireless communication projects, such as long term evolution (LTE) or the like. Still further, the electronic device 100 may be capable of operating in accordance with fourth generation (4G) communication protocols.

In an alternative embodiment, the electronic device 100 may be capable of operating in accordance with a non-cellular communication mechanism. For example, the electronic device 100 may be capable of communication in a wireless local area network (WLAN), other communication networks, and/or the like. Further, the electronic device 100 may communicate in accordance with techniques, such as radio frequency (RF), infrared (IrDA), any of a number of WLAN techniques. For example, the electronic device 100 may communicate using one or more of the following WLAN techniques: IEEE 802.11, e.g., 802.11a, 802.11b, 802.11g, 802.11n, and/or the like. Further, the electronic device 100 may also communicate, via a world interoperability, to use a microwave access (WiMAX) technique, such as IEEE 802.16, and/or a wireless personal area network (WPAN) technique, such as IEEE 802.15, BlueTooth (BT), ultra wideband (UWB), and/or the like.

It should be understood that the communications protocols described above may employ the use of signals. In an example embodiment, the signals comprises signaling information in accordance with the air interface standard of the applicable cellular system, user speech, received data, user generated data, and/or the like. In an embodiment, the electronic device 100 may be capable of operating with one or more air interface standards, communication protocols, modulation types, access types, and/or the like. It should be further understood that the electronic device 100 is merely illustrative of one type of electronic device that would benefit from embodiments of the invention and, therefore, should not be taken to limit the scope of embodiments of the invention.

While embodiments of the electronic device 100 are illustrated and will be hereinafter described for purposes of example, other types of electronic devices, such as a portable digital assistant (PDA), a pager, a mobile television, a gaming device, a camera, a video recorder, an audio player, a video player, a radio, a mobile telephone, a traditional computer, a portable computer device, a global positioning system (GPS) device, a GPS navigation device, a GPS system, a mobile computer, a browsing device, an electronic book reader, a combination thereof, and/or the like, may be used. While several embodiments of the invention may be performed or used by the electronic device 100, embodiments may also be employed by a server, a service, a combination thereof, and/or the like.

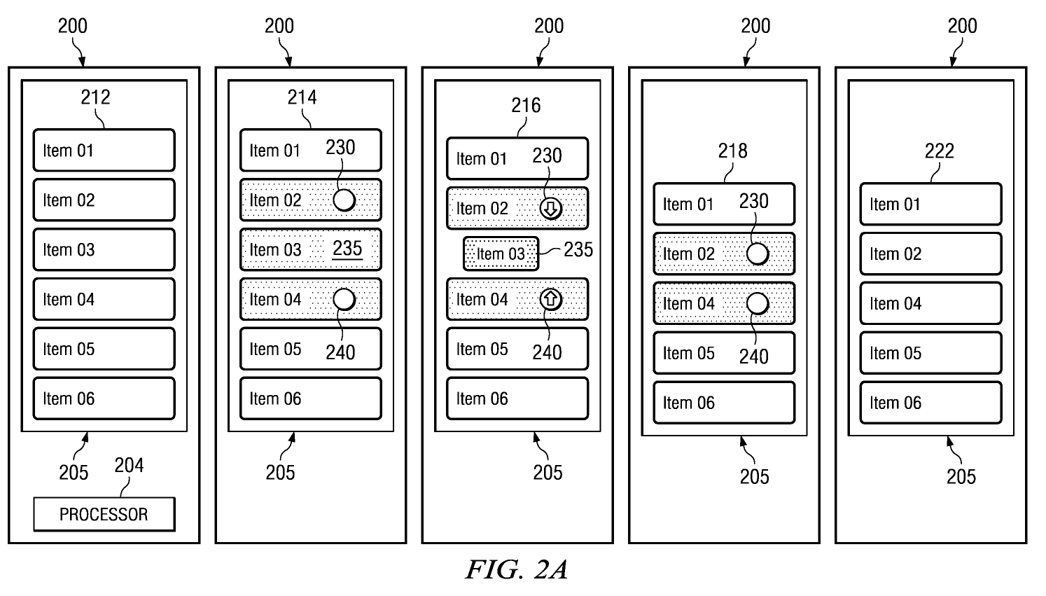

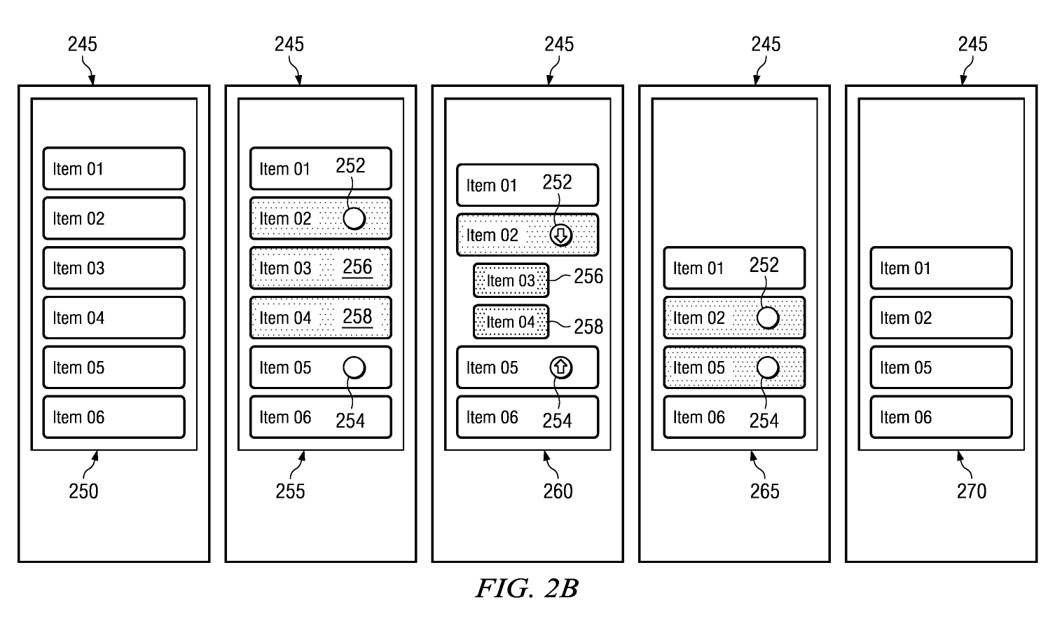

FIG. 2A is screen views 212, 214, 216, 218, 222 of an electronic device 200 deleting an item in accordance with an example embodiment of the invention. In an example embodiment, the electronic device 200 comprises a user interface 205 and/or a processor 204. In an example embodiment, the electronic device 200 is similar to electronic device 100 of FIG. 1 and the processor 204 is similar to processor 20 of FIG. 1. In an alternative embodiment, the electronic device 200 is different than electronic device 100 of FIG. 1 and the processor 204 is different than processor 20 of FIG. 1.

In an example embodiment, the user interface 205 is configured to display one or more items. In an example embodiment, the user interface 205 is configured to display the one or more items in a vertical manner. For example, the user interface 205 displays 6 thumbnails or image names as shown in screen view 212. In an example embodiment, the user interface 205 may display the one or more items in a vertical manner, horizontal manner, grid-like manner, on an identified location of a screen, such as a top of a screen, and/or the like. In an embodiment, a list comprises one or more items. In an embodiment, the list comprises a playlist, widgets, and/or the like. In an embodiment, the item is at least one of the following: an icon, a song title, a widget name, a thumbnail, a file name, and/or the like.

In an embodiment, screen view 214 displays a first touch position 230 and a second touch position 240. Further, an item, such as item 235, may be located in between the first touch position 230 and the second touch position 240.

In an example embodiment, the user interface 205 is configured to detect a first touch as shown in screen view 216. In an example embodiment, the first touch is at least one of the following: a finger press, a pinch, and/or the like. For example, a user presses on the first touch position 230 with a finger. In an embodiment, the user interface 205 detects a finger press on the first touch position 230. In an alternative embodiment, the user interface 205 detects a pinch. For example, a user pinches with a finger on the first touch position 230 and another finger on the second touch position 240 Further, the user interface 205 is configured to detect a second touch. For example, the user interface 205 detects a finger press on the second touch position 240. In an example embodiment, the second touch is at least one of the following: a finger press, a sweep, and/or the like. Further still, the user interface 205 is configured to detect a movement from the first touch position 230 or the second touch position 240.

In an example embodiment, the user interface 205 is configured to detect a movement from the first touch on the first touch position 230. In an alternative embodiment, the user interface 205 is configured to detect a movement from the second touch on the second touch position 240. In yet another alternative embodiment, the user interface 205 is configured to detect a movement from the first touch on the first touch position 230 and the second touch in the second touch position 240.

In an example embodiment, the user interface 205 detects a user moving a finger from the first touch position 230 towards the second touch position 240. Further, the user interface 205 detects another finger moving from the second touch position 240 towards the first touch position 230 in, for example, a pinching motion as shown in screen view 216. In such a case, the processor 204 is configured to delete or add at least one item based at least in part on the movement. For example, the processor 204 deletes item 235 based on the movement, e.g., pinching motion, over the item 235 as shown in screen view 218. In an embodiment, the deleted item 235 may be removed from the one or more items. For example, the user interface 205 does not display item 235 after deletion. In such an example, the user moves from the first touch position 230 and the second touch position 240 to view the non-deleted items as shown in screen view 222. A possible technical effect of one or more of the example embodiments disclosed herein is deleting an item on a user interface using a pinching motion.

In an example embodiment, the electronic device 200 uses one of many touch sensor technologies to detect. For example, the electronic device 200 uses a capacitive touch sensor, e.g., an analog capacitive sensor or a projected capacitive sensor, a resistive touch sensor, an optical touch sensor, an acoustic touch sensor, a force sensor, a vibration touch sensor, or any other suitable touch sensor. Use of other touch sensor technologies is also possible.

In an alternative embodiment, the electronic device 200 uses piezo actuator, which comprises a piezo element to generate an electrical signal in response to physical pressure, e.g., haptic feedback, such as the force exerted by a finger press. It should be understood that both the piezo sensors and the piezo actuator may be fabricated from a single piezo-electric element so as to be both coplanar and electronically isolated from one another. The difference in operation between the piezo sensors and the piezo actuator is achieved through a coupling of the piezo sensors and the piezo actuator to a voltage source and a differential voltage measurement device respectively.

In an example embodiment, example embodiments may be employed using a server. In an example embodiment, the server comprises a processor and/or a database. In an embodiment, the server and/or the processor comprise memory. For example, the server comprises volatile memory, such as random access memory (RAM). RAM may comprise a cache area for the temporary storage of data. Further, the server may also comprise non-volatile memory, such as read only memory (ROM), which may be embedded and/or may be removable. The non-volatile memory may also comprise an electrically erasable programmable read only memory (EEPROM), flash memory, and/or the like.

In an embodiment, the processor communicates with internal and/or external components through the input/output circuitry. Further, the processor may carry out a variety of techniques, as dictated by software instructions, firmware instructions, and/or the like.

In an embodiment, the server comprises one or more data storage devices, such as a removable disk drive, a hard drive, an optical drive, other hardware capable of reading and/or storing information, and/or the like. In an embodiment, software for carrying out operations stores and/or distribute on an optical media, a magnetic media, a flash memory, or other form of media capable of storing information, and/or the like. The optical media, magnetic media, flash memory, and/or the like may be inserted into, and/or read by, devices, such as the optical drive, the removable disk drive, the input/output circuitry, and/or the like.

In an embodiment, the server is coupled to an input/output interface for user interaction. The input/output interface may comprise a mouse, keyboard, microphone, touch pad, touch screen, voice-recognition system, monitor, light-emitting diode (LED) display, liquid crystal display (LCD), and/or the like. In an alternative embodiment, the user input/output interface is two separate interfaces.

In an embodiment, the server is configured with software that may be stored on any combination of RAM and persistent storage, e.g., a hard drive. Such software may be contained in fixed logic or read-only memory, or placed in RAM via portable computer readable storage media such as read-only-memory magnetic disks, optical media, flash memory devices, and/or the like. In an alternative embodiment, the software is stored in RAM by way of data transmission links coupled to the input/output circuitry. Such data transmission links may comprise wired/wireless network interfaces, universal serial bus (USB) interfaces, and/or the like.

In an embodiment, the server comprises a network interface for interacting with client and server entities via a network. The network interface may include a combination of hardware and software components, including media access circuitry, drivers, programs, and protocol modules.

FIG. 2B is screen views 250, 255, 260, 265, 270 of an electronic device 245 deleting more than one item in accordance with an example embodiment of the invention. In an example embodiment, the electronic device 245 comprises a user interface and/or a processor. In an example embodiment, the electronic device 245 is similar to electronic device 100 of FIG. 1 and the processor is similar to processor 20 of FIG. 1. In an alternative embodiment, the electronic device 245 is different than electronic device 100 of FIG. 1 and the processor is different than processor 20 of FIG. 1.

In an example embodiment, the user interface is configured to display one or more items. In an example embodiment, the user interface is configured to display the one or more items in a vertical manner. For example, the user interface displays 6 thumbnails or image names as shown in screen view 250. In an example embodiment, the user interface is configured to detect a first touch as shown in screen view 255. For example, the user interface detects a finger press on the first touch position 252. Further, the user interface is configured to detect a second touch. For example, the user interface detects a finger press on the second touch position 254. Further still, the user interface is configured to detect a movement from the first touch position 252 or the second touch position 254.

In an example embodiment, the user interface detects a user moving a finger from the first touch position 252 towards the second touch position 254. Further, the user interface detects another finger moving from the second touch position 254 towards the first touch position 252 in, for example, a pinching motion as shown in screen view 260. In such a case, the processor is configured to delete or add at least one item based at least in part on the movement. For example, the processor deletes more than one item, such as items 256, 258 based at least in part on the movement, e.g., pinching motion, as shown in screen view 265. In an embodiment, the user moves from the first touch position 252 and the second touch position 254 to view the items as shown in screen view 270.

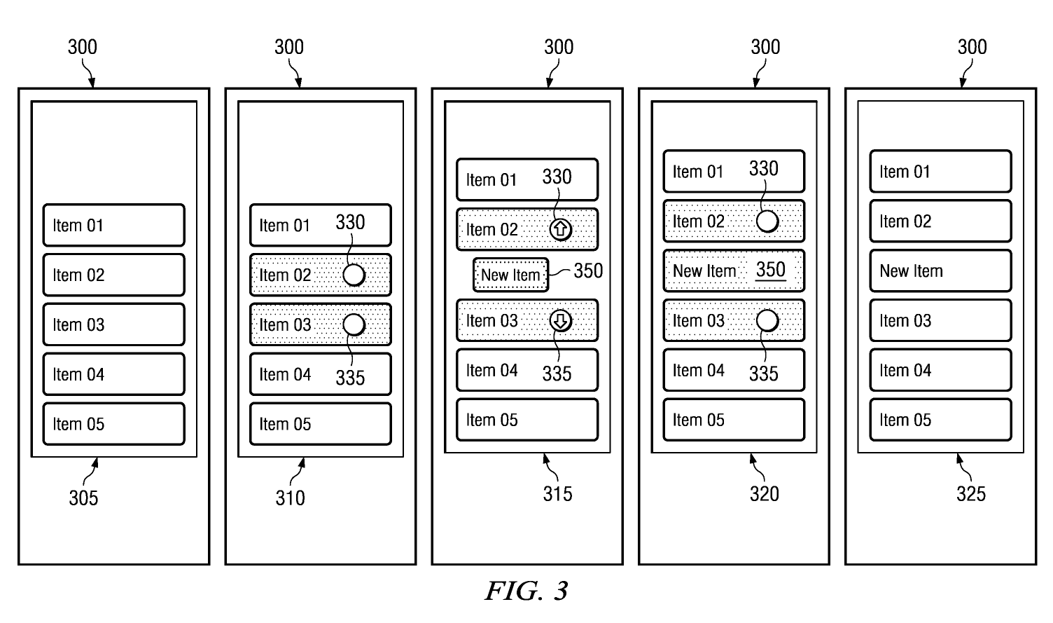

FIG. 3 is screen views 305, 310, 315, 320, 325 of an electronic device 300 adding an item in accordance with an example embodiment of the invention. In an example embodiment, the electronic device 300 comprises a user interface and/or a processor. In an example embodiment, the electronic device 300 is similar to electronic device 100 of FIG. 1 and the processor is similar to processor 20 of FIG. 1. In an alternative embodiment, the electronic device 300 is different than electronic device 100 of FIG. 1 and the processor is different than processor 20 of FIG. 1.

In an example embodiment, the user interface is configured to display one or more items. In an example embodiment, the user interface is configured to display the one or more items in a vertical manner. For example, the user interface displays 6 thumbnails or image names as shown in screen view 305. In an example embodiment, the user interface is configured to detect a first touch as shown in screen view 310. For example, the user interface detects a finger press on the first touch position 330. Further, the user interface is configured to detect a second touch. For example, the user interface detects a finger press on the second touch position 335. Further still, the user interface is configured to detect a movement from the first touch position 330 or the second touch position 335.

In an example embodiment, the user interface detects a user moving a finger from the first touch position 330 away from the second touch position 335. Further, the user interface detects another finger moving from the second touch position 335 away from the first touch position 330 as shown in screen view 315. In such a case, the processor is configured to delete or add at least one item based at least in part on the movement. For example, the processor adds at least one item, such as item 350 based at least in part on the movement as shown in screen view 320. In an example embodiment, a user interface of the electronic device 300 displays the added item 350. For example, a user views each of the items as shown in screen view 325. A possible technical effect of one or more of the example embodiments disclosed herein is adding an item on a user interface using a movement.

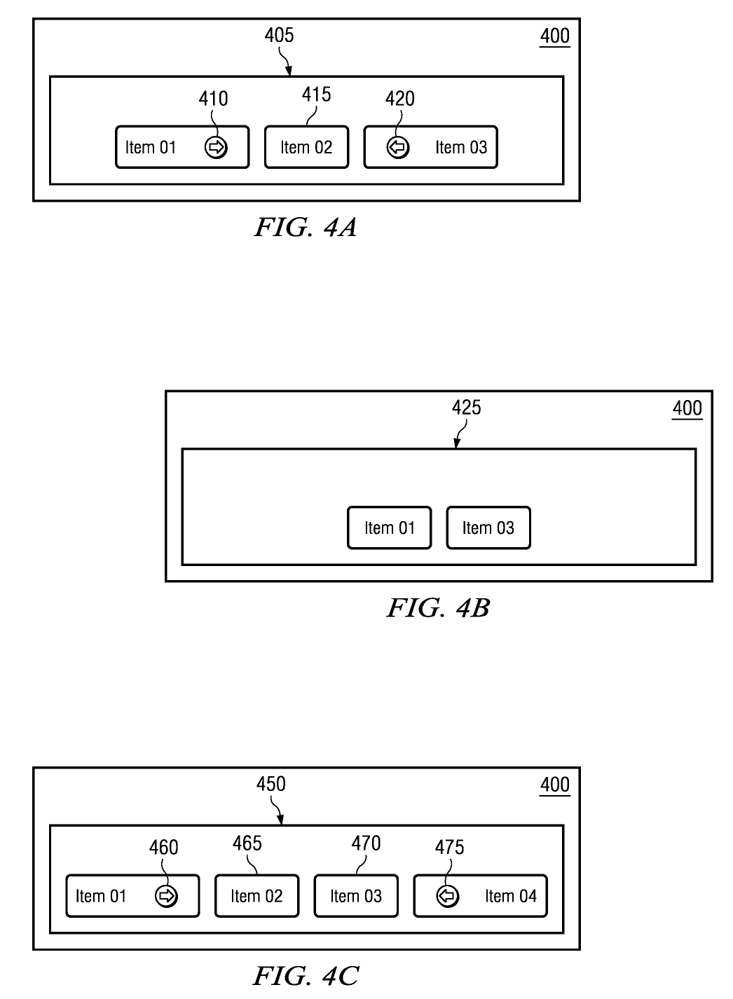

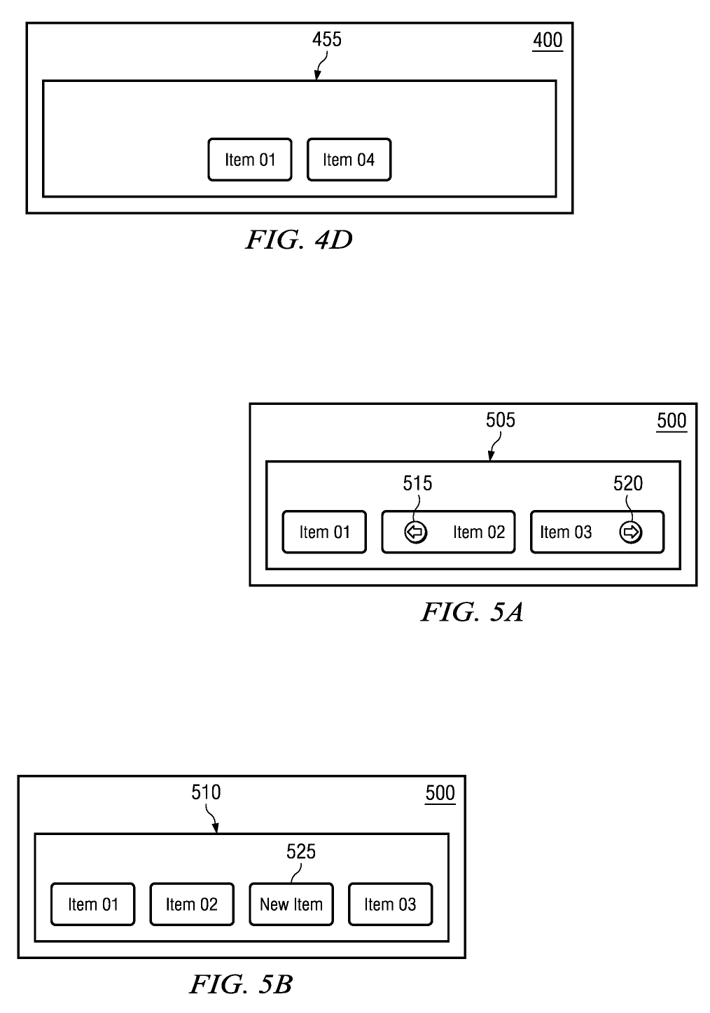

FIGS. 4A-B is screen views of another electronic device deleting an item in accordance with an example embodiment of the invention. In an example embodiment, the electronic device 400 comprises a user interface and/or a processor. In an example embodiment, the electronic device 400 is similar to electronic device 100 of FIG. 1 and the processor is similar to processor 20 of FIG. 1. In an alternative embodiment, the electronic device 400 is different than electronic device 100 of FIG. 1 and the processor is different than processor 20 of FIG. 1.

In an example embodiment, the user interface is configured to display items in a horizontal manner. In an example embodiment, the user interface detects a user moving a finger from a first touch position 410 to the right towards a second touch position 420. Further, the user interface detects another finger moving from the second touch position 420 to the left towards the first touch position 410 in, for example, a pinching motion as shown in screen view 405. In such a case, the processor is configured to delete or add at least one item based at least in part on the movement. For example, the processor deletes item 415 based on the movement, e.g., pinching motion, over the item 415 as shown in screen view 425.

FIGS. 4C-D is screen views of another electronic device deleting more than one item in accordance with an example embodiment of the invention. In an example embodiment, the electronic device 400 comprises a user interface and/or a processor. In an example embodiment, the electronic device 400 is similar to electronic device 100 of FIG. 1 and the processor is similar to processor 20 of FIG. 1. In an alternative embodiment, the electronic device 400 is different than electronic device 100 of FIG. 1 and the processor is different than processor 20 of FIG. 1.

In an example embodiment, the user interface is configured to display items in a horizontal manner. In an embodiment, the user interface detects a user moving a finger from the first touch position 460 to the right towards the second touch position 475. Further, the user interface detects another finger moving from the second touch position 475 to the left towards the first touch position 460 in, for example, a pinching motion as shown in screen view 450. In such a case, the processor is configured to modify at least one item based at least in part on the movement. For example, the processor deletes more than one item, such as items 465, 470 based at least in part on the movement, e.g., pinching motion, as shown in screen view 455.

FIGS. 5A-B is screen views of another electronic device adding an item in accordance with an example embodiment of the invention. In an example embodiment, the electronic device 500 comprises a user interface and/or a processor. In an example embodiment, the electronic device 500 is similar to electronic device 100 of FIG. 1 and the processor is similar to processor 20 of FIG. 1. In an alternative embodiment, the electronic device 500 is different than electronic device 100 of FIG. 1 and the processor is different than processor 20 of FIG. 1.

In an example embodiment, the user interface is configured to display items in a horizontal manner. In an example embodiment, the user interface detects a user moving a finger from the first touch position 515 to the left, e.g., away, from the second touch position 520. Further, the user interface detects another finger moving to the right, e.g. away, from the second touch position 520 as shown in screen view 505. In such a case, the processor is configured to modify at least one item based at least in part on the movement. For example, the processor add at least one item, such as item 525 based at least in part on the movement as shown in screen view 510.

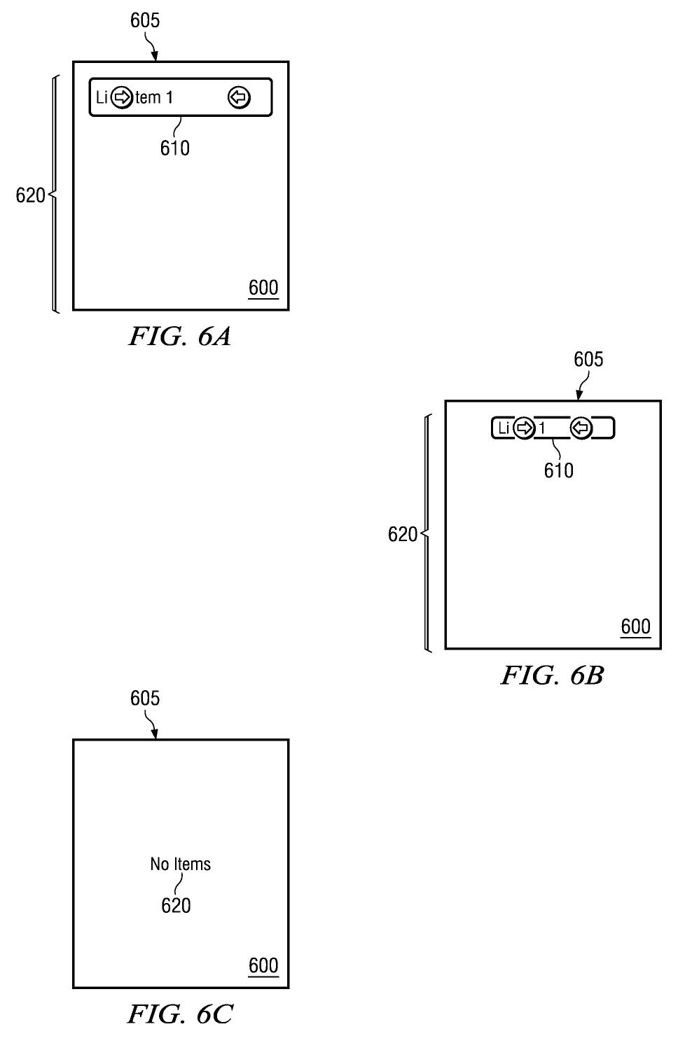

FIGS. 6A-C is screen views of another electronic device 600 deleting an item in accordance with an example embodiment of the invention. In an example embodiment, the electronic device 600 comprises a user interface and/or a processor. In an example embodiment, the electronic device 600 is similar to electronic device 100 of FIG. 1 and the processor is similar to processor 20 of FIG. 1. In an alternative embodiment, the electronic device 600 is different than electronic device 100 of FIG. 1 and the processor is different than processor 20 of FIG. 1.

In an example embodiment, the user interface 605 displays a list 620. The list 620 may comprise one or more items, such as item 610. In an embodiment, the user interface 605 displays item 610 as shown in FIG. 6A. In an embodiment, the item 610 may be deleted using a horizontal pinch. For example, a user deletes a last item, such as item 610, by pinching in a horizontal manner as shown in FIG. 6B. In such an example, the item 610 is deleted from the list 620. Since, for example, item 610 is the only item in the list 620, the user interface 605 displays the list 620 with no items as shown in FIG. 6C.

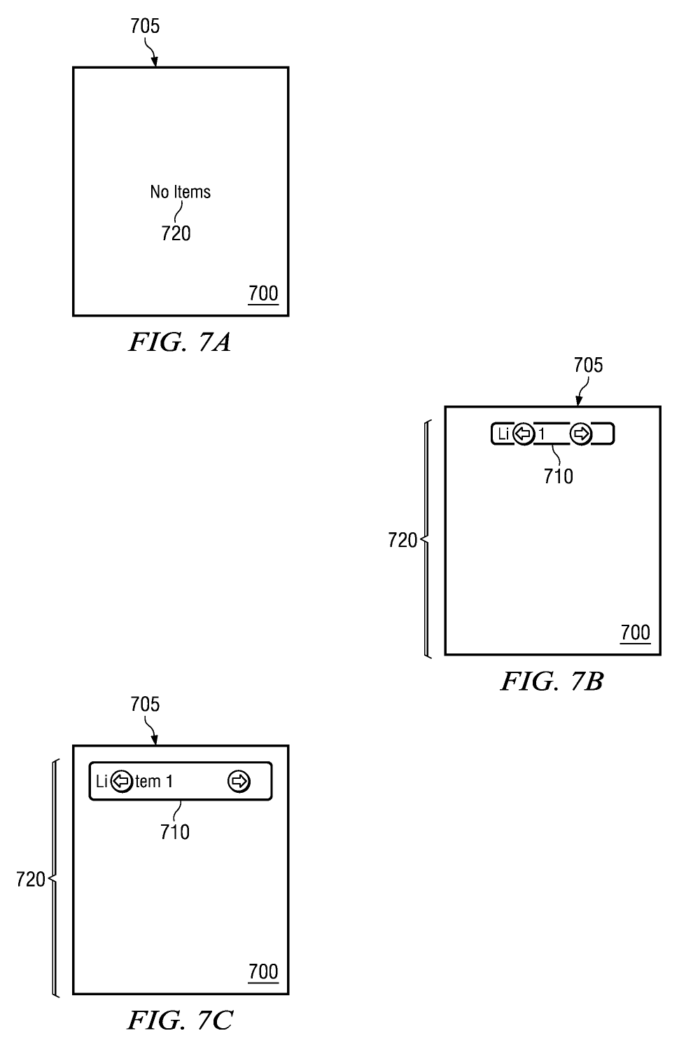

FIGS. 7A-C is screen views of another electronic device 700 adding an item in accordance with an example embodiment of the invention.

In an example embodiment, the electronic device 700 comprises a user interface and/or a processor. In an example embodiment, the electronic device 700 is similar to electronic device 100 of FIG. 1 and the processor is similar to processor 20 of FIG. 1. In an alternative embodiment, the electronic device 700 is different than electronic device 100 of FIG. 1 and the processor is different than processor 20 of FIG. 1.

In an example embodiment, the user interface 705 displays a list 720. The list 720 may comprise one or more items. In an embodiment, the user interface 705 displays an empty list, e.g., no items, as shown in FIG. 7A. In an embodiment, an item 710 may be added using a horizontal pinch. For example, a user adds a first item, such as item 710 by pinching in a horizontal manner as shown in FIG. 7B. In such an example, the item 710 is added to the list 720. The user interface 705 displays the list 720 with the item 710 as shown in FIG. 7C.

Without in any way limiting the scope, interpretation, or application of the claims appearing below, it is that possible a technical effect of one or more of the example embodiments disclosed herein may be deleting an item on a user interface using a pinching motion. Another possible technical effect of one or more of the example embodiments disclosed herein may be adding an item on a user interface using a movement.

Embodiments of the present invention may be implemented in software, hardware, application logic or a combination of software, hardware and application logic. The software, application logic and/or hardware may reside on an electronic device or server. If desired, part of the software, application logic and/or hardware may reside on an electronic device, part of the software and part of the software, application logic and/or hardware may reside on server. The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
a user interface configured to:
detect a first touch;
detect a second touch;
detect a movement from the first touch or the second touch; and
a processor configured to:
delete or add at least one item based at least in part on the movement.

2. The apparatus of claim 1 wherein the user interface is further configured to detect a movement from the first touch and the second touch.

3. The apparatus of claim 1 wherein the first touch or the second touch is a finger press.

4. The apparatus of claim 1 wherein the movement is a pinch.

5. The apparatus of claim 1 wherein the at least one item is at least one of the following: an icon, a song title, a widget name, a thumbnail, or a file name.

6. The apparatus of claim 1 wherein delete or add at least one item is performed by at least one of the following: a server or electronic device.

7. The apparatus of claim 1 wherein a last item is deleted from a list.

8. The apparatus of claim 1 wherein a first item is added from a list.

9. The apparatus of claim 1, wherein the processor comprises at least one memory that contains executable instructions that if executed by the processor cause the apparatus to delete or add at least one item based at least in part on the movement.

10. A method, comprising:
detecting a first touch;
detecting a second touch;
detecting a movement from the first touch or the second touch; and
deleting or adding at least one item based at least in part on the movement.

11. The method of claim 10 further comprising detecting a movement from the first touch and the second touch.

12. The method of claim 10 wherein the first touch or the second touch is a finger press.

13. The method of claim 10 wherein the movement is a pinch.

14. The method of claim 10 wherein the at least one item comprises at least one of the following: an icon, a song title, a widget name, a thumbnail, or a file name.

15. The method of claim 10 wherein deleting or adding at least one item is performed by at least one of the following: a server or electronic device.

16. The method of claim 10 wherein a last item is deleted from a list.

17. The method of claim 10 wherein a first item is added from a list.

18. A computer program product comprising a computer-readable medium bearing computer program code embodied therein for use with a computer, the computer program code comprising:
code for detecting a first touch;
code for detecting a second touch;
code for detecting a movement from the first touch or the second touch; and
code for deleting or adding at least one item based at least in part on the movement.

19. The computer program product of claim 18 further comprising detecting a movement from the first touch and the second touch.

20. The computer program product of claim 18 wherein the at least one item comprises at least one of the following: an icon, a song title, a widget name, a thumbnail, or a file name.

21-35. (canceled)
